(19) United States
(12) Patent Application Publication
(10) Pub. No.: US 2012/0285765 A1
(43) Pub. Date: Nov. 15, 2012

(54) CONTINUOUSLY VARIABLE STEERING APPARATUS

(75) Inventor: Joshua Zulu, Germantown Hills, IL (US)

(73) Assignee: Caterpillar Inc., Peoria, IL (US)

(21) Appl. No.: 13/103,327

(22) Filed: May 9, 2011

(51) Int. Cl. B62D 5/065

(52) U.S. Cl. 180/431; 180/417

(57) ABSTRACT

A steering apparatus for providing a variable speed output from a mechanical power source and a hydraulic power source is disclosed. The steering apparatus includes a rotatable housing, a hydraulic motor mounted within the rotatable housing. The hydraulic motor includes a rotor and a casing. The steering apparatus further includes a first output shaft connected to the rotor and a second output shaft connected to the casing. The first output shaft is configured to be selectively engaged and disengaged with the rotatable housing. The second output shaft is configured to be selectively engaged and disengaged with the rotatable housing.

### TECHNICAL FIELD

The present disclosure relates to a steering apparatus, and more particularly to a hydro-mechanical steering apparatus to provide variable speed output.

### BACKGROUND

Various steering apparatuses known in the art have been proposed for use in machines to provide steering function. For example, a planetary steering differential which includes a hydraulic motor to externally power one of the drive shafts of a machine to increase or decrease the relative speeds at the drive shafts. Further, U.S. Pat. No. 5,545,098 discloses a hydro-mechanical steering apparatus which provides a variable speed and torque output from an external mechanical power source and an external hydraulic power source. However, more work can still be done in this area to reduce the number of components and reduce overall cost of the steering apparatus.

### SUMMARY

In one aspect, the present disclosure provides a steering apparatus to provide a variable speed output from a mechanical power source and a hydraulic power source without interrupting main power flow to the ground. The steering apparatus includes a rotatable housing and a hydraulic motor mounted within the rotatable housing. The hydraulic motor includes a rotor and a casing. The steering apparatus also includes a first output shaft and a second output shaft connected to the rotor and the casing, respectively. The rotatable housing, the first output shaft, and the second output shaft are rotatable about a central axis. Further, the first output shaft and the second output shaft are configured to be selectively engaged and disengaged to the rotatable housing.

Other features and aspects of the present disclosure will be apparent from the following description and the accompanying drawings.

### BRIEF DESCRIPTION OF THE DRAWINGS

FIG. 1 is a schematic diagram of a machine having a steering apparatus, according to an aspect of this disclosure;

FIG. 2 is a schematic diagram of the steering apparatus shown in FIG. 1, according to an aspect of this disclosure;

FIG. 3 is a schematic diagram of the steering apparatus shown in FIG. 1, according to another aspect of this disclosure; and

FIG. 4 is a schematic diagram of the steering apparatus shown in FIG. 1, according to yet another aspect of this disclosure.

### DETAILED DESCRIPTION

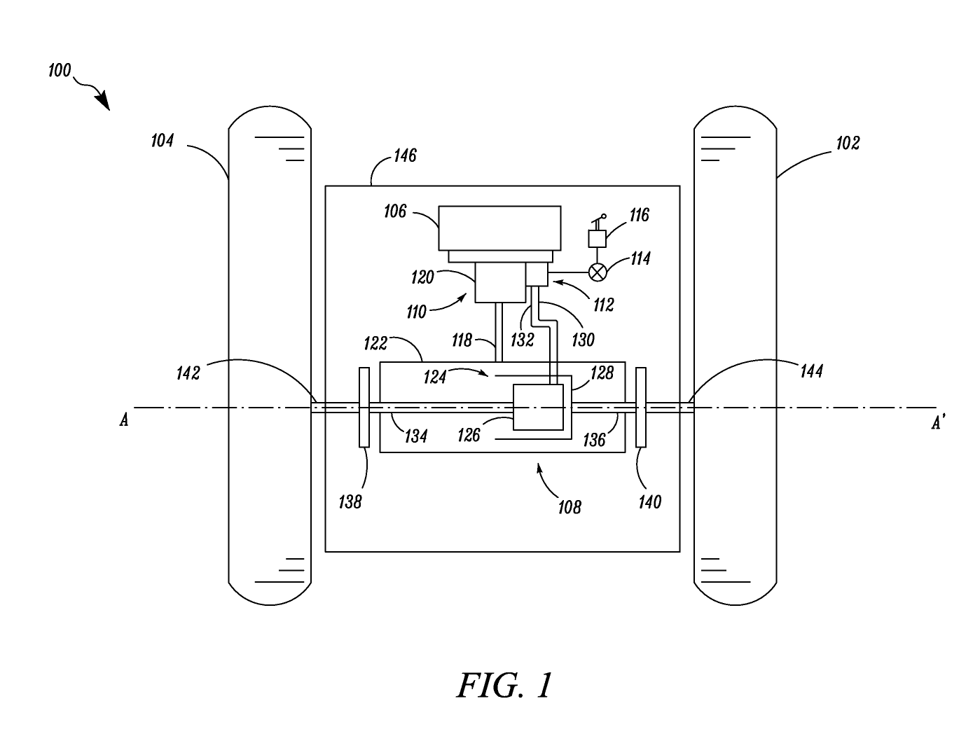

FIG. 1 shows a schematic diagram of a machine 100, according to an aspect of this disclosure. The machine 100 may include a tracked or a wheeled vehicle, for example, but not limited to, off-highway trucks, on-highway trucks, articulated trucks, wheel tractors, track type tractors, wheel tractor-scrapers, wheel loaders, compactors, excavators, dozers, motor graders, any moving machine, or other machine using a transmission system for steering. In an embodiment, as shown in FIG. 1, the machine 100 may embody a tracked vehicle having a right side track 102, and a left side track 104.

The machine 100 may include a mechanical power source, such as an internal combustion engine 106, a steering apparatus 108, and a drive train 110 for coupling the internal combustion engine 106 to the steering apparatus 108. The machine 100 may further include a hydraulic power source, such as a fixed displacement (for open loop circuit) or variable displacement (for closed loop circuit) hydraulic pump 112, which may be of any well-known construction. The hydraulic pump 112 may be controlled through a valve 114 operated by a control lever 116. The hydraulic pump 112 may also be hydraulically and/or electronically controlled using an electro-hydraulic transducer valve.

The drive train 110 may include an input shaft 118 to interconnect the internal combustion engine 106 to the steering apparatus 108. The drive train 110 may, but is not required to, also include a conventional mechanical transmission or a gear reduction unit 120 that may be interposed between the internal combustion engine 106 and the steering apparatus 108. Further, the drive train 110 may also include a set of gears for powering the hydraulic pump 112.

In an embodiment, the steering apparatus 108 may include a rotatable housing 122, and a hydraulic motor 124 mounted within the rotatable housing 122. The hydraulic motor 124 may include a rotor 126 and a casing 128. The hydraulic motor 124 may be a low speed, high torque type motor of any well-known construction. However, it should be understood that this disclosure is not intended to be limited to a particular motor type, as those skilled in the art will readily be able to adapt to the types of motors, for example, a radial or an axial piston type hydraulic motor, without departing from the teachings hereof. A first hydraulic line 130 and a second hydraulic line 132 may connect the hydraulic pump 112 to an inlet and an outlet port of the hydraulic motor 124.

The steering apparatus 108 may also include a first output shaft 134 and a second output shaft 136 connected to the rotor 126 and the casing 128, respectively. Alternatively, the first and the second output shafts 134 and 136 may be integral to the rotor 126 and the casing 128, respectively. In an embodiment, the first output shaft 134 and the second output shaft 136 may be configured to be selectively engaged and disengaged to the rotatable housing 122.

Further, the steering apparatus 108 may include a first gear assembly 138 and a second gear assembly 140, such that the first gear assembly 138 and the second gear assembly 140 are driven by the first output shaft 134 and the second output shaft 136, respectively. In an embodiment, the first and the second gear assemblies 138 and 140 may include a planetary gearing mechanism. Alternatively, the first and the second gear assemblies 138 and 140 may include other types of gearing mechanism for example, but not limited to, pinion and wheel gear mechanism with spur, helical or double helical configuration. Further, the first and the second gear assemblies 138 and 140 may be drivably connected to respective sprockets of the left side track 104 and the right side track 102 via a first drive shaft 142 and a second drive shaft 144, respectively.

The machine 100 may include a chassis portion 146 which may support the one or more components of the mechanical power source, the hydraulic power source, the steering apparatus 108, the first gear assembly 138, and the second gear assembly 140. Further, the rotatable housing 122, the first output shaft 134, and the second output shaft 136 may be rotatable about a central axis AA′. In an embodiment, the steering apparatus 108 may be located at a rear part of the chassis portion 146 in order to place the central axis AA′ thereof substantially in line with, or near the axis of the sprockets that drive the right and the left side tracks 102 and 104.

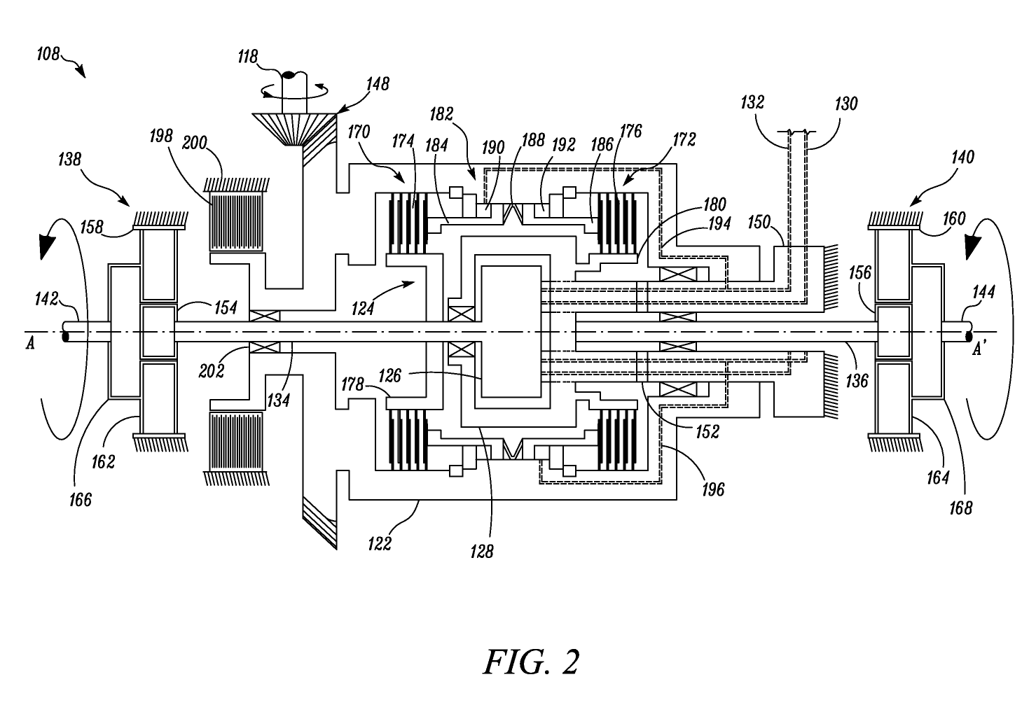

Referring now to FIGS. 2-4, which show schematic diagrams of the steering apparatus 108, shown in FIG. 1. As shown in FIG. 2, the rotatable housing 122 may be connected to the input shaft 118 of the drive train 110 (see FIG. 1), via a bevel gear assembly 148. The bevel gear assembly 148 may impart an input, i.e. a rotational movement, to the rotational housing 122 from the internal combustion engine 106.

Further, the hydraulic motor 124 may be mounted within the rotatable housing 122 in a coaxial alignment about the central axis AA′. The hydraulic pump 112 (see FIG. 1) may impart a variable input, i.e. a variable rotational movement, to the hydraulic motor 124. As shown in FIG. 2, the first hydraulic line 130 and the second hydraulic line 132 may be connected to the rotor 126, of the hydraulic motor 124, through a hydraulic manifold 150, a dual path port plate 152 and casing 128. One of the first hydraulic line 130 and the second hydraulic line 132 may supply a pressurized fluid to the rotor 126 based on the actuation of the control lever 116 (see FIG. 1). Moreover, a dual pressure plate forming a swivel joint may be provided between the dual path port plate 152 and the rotor 126 to continuously supply the pressurized fluid while the rotor 126 rotates. The swivel joint may provide a hydrodynamic sealing force proportional to the supplied pressure and also continuously adjust for any wear.

As shown in FIG. 2, the first and the second output shafts 134 and 136 may be integral to the rotor 126 and the casing 128, respectively and drivably connected to sun gears 154 and 156 of the first and the second gear assemblies 138 and 140. The first and the second gear assemblies 138 and 140 may further include respective ring gears 158 and 160, and set of planet gears 162 and 164. Two carrier members 166 and 168 may be attached to the set of planet gears 162 and 164, respectively. The carrier members 166 and 168 may be integral with the respective first drive shaft 142 and the second drive shaft 144. A combined output of the input from the mechanical power source and the variable input from the hydraulic power source may be provided to the right side and the left side tracks 102 and 104 via the second and the first drive shafts 144 and 142, respectively.

The steering apparatus 108 may further include a first clutch member 170 and a second clutch member 172. The first clutch member 170 may be associated with the rotatable housing 122 to selectively engage and disengage the first output shaft 134 to the rotatable housing 122. Further, the second clutch member 172 may also be associated with the rotatable housing 122 to selectively engage and disengage the second output shaft 136 to the rotatable housing 122.

In an embodiment, the first clutch member 170 and the second clutch member 172 may include a first set of disks 174 and a second set of disks 176, respectively. The first set of disks 174 may include a plurality of intermeshed disk portions which may be connected to the rotatable housing 122 and a flange portion 178 of the first output shaft 134. The second set of disks 176 may also include a plurality of intermeshed disk portions which may be connected to the rotatable housing 122 and a flange portion 180 of the second output shaft 136. Further, a clutch engagement and release mechanism 182 may be provided to apply a force to the intermeshed disk portions of the first clutch member 170 and the second clutch member 172. Thus, the rotational movement of the rotatable housing 122 may be selectively transmitted to the first output shaft 134 and the second output shaft 136. The intermeshed disk portions of the first and the second set of disks 174 and 176 may include frictional facing surfaces made of an organic resin with metallic wire or a ceramic material. The respective facing surfaces may also have a coating of a ceramic material to provide a high coefficient of friction.

In an embodiment, the clutch engagement and release mechanism 182 may include a first piston 184, a second piston 186, and a resilient member 188. The first and the second pistons 184 and 186 may be disposed within a first clutch release chamber 190 and a second clutch release chamber 192, respectively, of the rotatable housing 122. The resilient member 188 may be positioned between the first and the second pistons 184 and 186, and apply a compressive force on the first and the second set disks 174 and 176 of the first clutch member 170 and the second clutch member 172. In an embodiment, the resilient member 188 may be a dual belleville spring pack. Alternatively, the resilient member 188 may be a compression spring well known in the art.

A first pressure release line 194 and a second pressure release line 196 may connect the first clutch release chamber 190 and the second clutch release chamber 192 to the second hydraulic line 132 and the first hydraulic line 130, respectively. In response to a flow of the pressurized fluid through one of the first and the second hydraulic lines 130 and 132, the first and the second pistons 184 and 186 may move against the compressive force of the resilient member 188. The movement of the first and the second pistons 184 and 186 may selectively disengage the first and the second clutch members 170 and 172.

A brake member 198 may be provided to selectively engage and disengage the rotatable housing 122 to a stationary housing 200. The stationary housing 200 may be integral with the chassis 146 (see FIG. 1) of the machine 100. The brake member 198 may be actuated by hydraulic connectors similar to the clutch engagement and release mechanism 182 for the first and the second clutch members 170 and 172. Moreover, a typical bearing support 202 may be provided between the rotatable housing 122 and the first output shaft 134 to allow a constrained relative motion therebetween. However, one or more bearing supports may also be provided between the rotatable housing 122 and the second output shaft 136.

Referring again to FIG. 2, in an aspect of the present disclosure, the pressurized fluid may not be supplied to the first and the second hydraulic lines 130 and 132. Thus, the first and the second clutch members 170 and 172 are engaged with the flange portions 178 and 180, respectively.

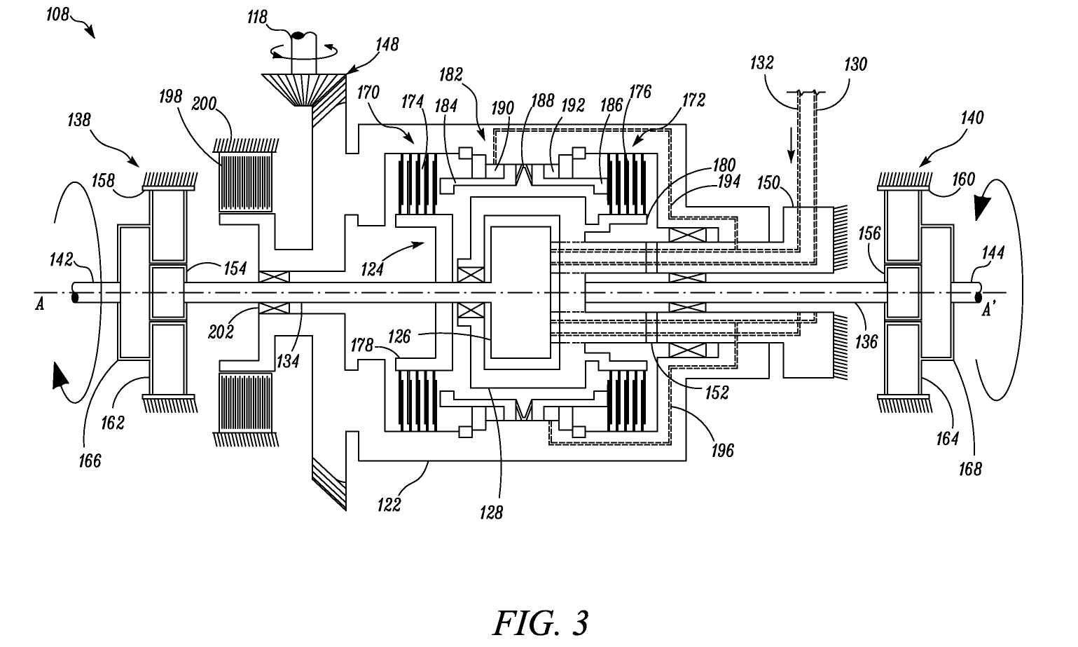

FIG. 3 shows the pressurized fluid may be supplied through the second hydraulic line 132 to impart rotation to the rotor 126 in a direction opposite to the rotation of the rotatable housing 122. Further, the first clutch member 170 is disengaged from the flange portion 178 and the second clutch member 172 stays engaged with the flange portion 180.

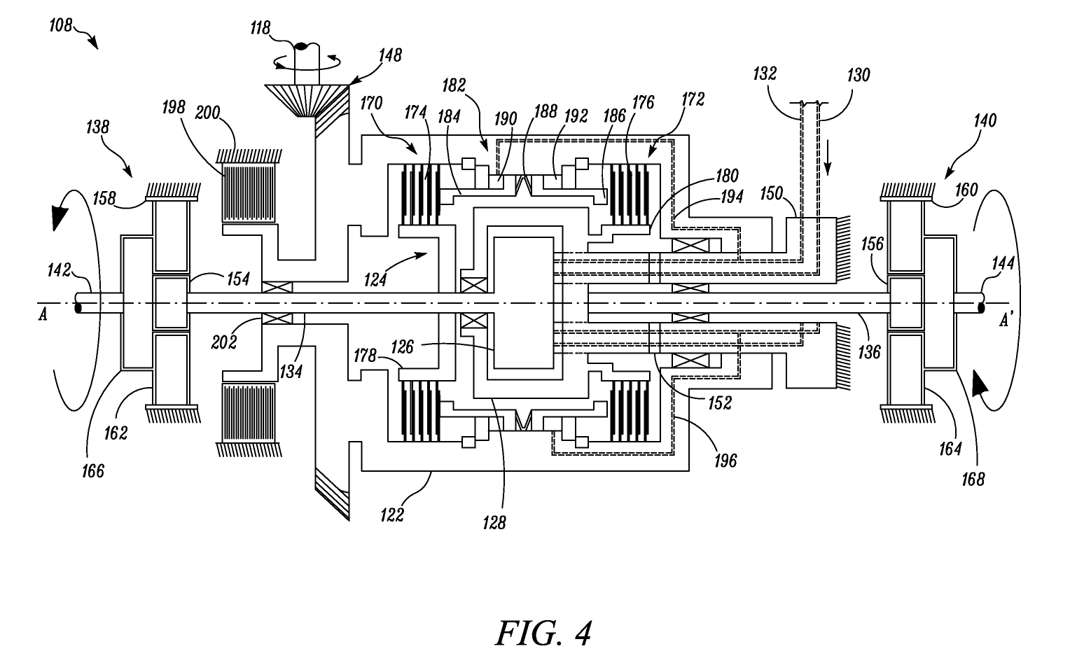

FIG. 4 shows the pressurized fluid may be supplied through the first hydraulic line 130 to impart rotation to the casing 128 in a direction opposite to the rotation of the rotatable housing 122. Further, the first clutch member 170 stays engaged with the flange portion 178 and the second clutch member 172 is disengaged from the flange portion 180.

### INDUSTRIAL APPLICABILITY

The steering apparatus 108 described above provides a combined output with uninterrupted power flow from the mechanical power source. Further, the combined output can be continuously varied using the hydraulic power source. During operation of the machine 100, the input from the mechanical power source, such as the internal combustion engine 106, is transferred through the input shaft 118 to the rotatable housing 122, thereby rotating the rotatable housing 122. Further, an operator may control the flow of pressurized fluid from the hydraulic power source, such as the hydraulic pump 112, to provide the variable input through the hydraulic motor 124. The combined output of the input and the variable input from the internal combustion engine 106 and the hydraulic pump 112, respectively, may be transmitted to the right side and the left side tracks 102 and 104 of the machine 100. The combined output may provide both drive and steering functions to the machine 100.

For a straight travel operation, the hydraulic pump 112 may not supply any pressurized fluid to the first and the second hydraulic lines 130 and 132. Therefore, the first and the second pressure release lines 194 and 196 may not supply pressurized fluid to the first and the second clutch release chambers 190 and 192. The compressive force of the resilient member 188 may be transferred to the first and the second set of disks 174 and 176 through the first and the second pistons 184 and 186, thus, engaging the first and the second clutch members 170 and 172 to the flange portions 178 and 180, respectively. Due to this, the first and second drive shafts 142 and 144 rotate with the rotatable housing 122 in the same direction and at the same speed.

For a left turn operation, the hydraulic pump 112 may supply the pressurized fluid to the second hydraulic line 132 to hydraulically hold or impart rotation to the rotor 126 in the direction opposite to the rotation of the rotatable housing 122. A portion of the pressurized fluid may also flow through the first pressure release line 194. The portion of the pressurized fluid may fill into the first clutch release chamber 190 and move the first piston 184 against the compressive force of the resilient member 188 (see FIG. 3). Thus, the compressive force of the resilient member 188 may be released on the first set of disks 174, disengaging the first clutch member 170. Due to this, the first drive shaft 142 may rotate in the direction opposite to the rotation of the rotatable housing 122 via the rotor 126. Moreover, the speed of the first drive shaft 142 can be continuously varied by regulating the flow of the pressurized fluid in the second hydraulic line 132.

Similarly, for a right turn operation, the hydraulic pump 112 may supply the pressurized fluid to the first hydraulic line 130 to hydraulically hold or impart rotation the casing 128 opposite to the rotation of the rotatable housing 122. A portion of the pressurized fluid may also flow through the second pressure release line 196. The portion of the pressurized fluid may fill into the second clutch release chamber 192 and move the second piston 186 against the compressive force of the resilient member 188 (see FIG. 4). Thus, the compressive force of the resilient member 188 may be released on the second set of disks 176, disengaging the second clutch member 172. Due to this, the second drive shaft 144 may rotate in the direction opposite to the rotation of the rotatable housing 122 via the casing 128. Moreover, the speed of the second drive shaft 144 can be continuously varied by regulating the flow of the pressurized fluid in the first hydraulic line 130.

Furthermore, during the left or right turning the variable input may be substantially equal and opposite to the input from the mechanical power source. Therefore, the machine 100 may steer with both the right side and the left side tracks 102 and 104 traversing a circular path about a pivot point centered near half way between the right side and the left side tracks 102 and 104. Therefore, the machine 100 may achieve a zero turning radius about the pivot point. Moreover, both the right side and the left side tracks 102 and 104 have sufficient traction, due to the input from the mechanical power source and the variable input from the hydraulic power source, and avoid any slippage during the turning.

The steering apparatus 108 according to this disclosure may require only one service brake member 198 which may be associated with the rotatable housing 122. Thus, the steering apparatus 108 according to this disclosure is cost effective in comparison with traditional differential steering arrangements which may require differential locks with higher number of brake and clutch members. In view of the foregoing, this disclosure provides a compact steering apparatus 108 to provide smooth and continuously controlled steering with uninterrupted power flow to the ground.

In addition, the steering apparatus 108 provides an inline continuously variable steering function by use of hydraulic motor and planetary gearing mechanism which is easy to manufacture and assemble. However, traditional hydro-mechanical steering apparatuses use specialized gears which may require expensive manufacturing processes, for example, machining and heat treatment and also difficult to assemble and service.

Aspects of this disclosure may also be applied to other machines in need of steering function. Although, the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of this disclosure. It is intended that the specification and examples be considered as exemplary only, with a true scope being indicated by the following claims and their equivalents.

What is claimed is:

1. A steering apparatus for providing a variable speed output from a mechanical power source and a hydraulic power source, the steering apparatus comprising:
a rotatable housing rotatable about a central axis;
a hydraulic motor mounted within the rotatable housing, the hydraulic motor including a rotor and a casing;
a first output shaft connected to the rotor of the hydraulic motor for rotation about the central axis, the first output shaft is configured to be selectively engaged and disengaged to the rotatable housing; and
a second output shaft connected to the casing of the hydraulic motor for rotation about the central axis, the second output shaft is configured to be selectively engaged and disengaged to the rotatable housing.

2. The steering apparatus of claim 1 further including a first clutch member associated with the rotatable housing to selectively engage and disengage the first output shaft to the rotatable housing.

3. The steering apparatus of claim 1 further including a second clutch member associated with the rotatable housing to selectively engage and disengage the second output shaft to the rotatable housing.

4. The steering apparatus of claim 1 further including a stationary housing, wherein the rotatable housing is configured to be selectively engaged and disengaged to the stationary housing.

5. The steering apparatus of claim 4 further including a brake member associated with the stationary housing to selectively engage and disengage the rotatable housing to the stationary housing.

6. The steering apparatus of claim 1 further including,
a first gear assembly driven by the first output shaft, the first gear assembly drives a first drive shaft; and
a second gear assembly driven by the second output shaft, the second gear assembly drives a second drive shaft.

7. The steering apparatus of claim 6, wherein at least one of the first gear assembly and the second gear assembly is a planetary gearing mechanism.

8. The steering apparatus of claim 1, wherein the hydraulic motor is one of an axial piston motor and a radial piston motor.

9. A steering apparatus for providing a variable speed output from a mechanical power source and a hydraulic power source, the steering apparatus comprising:
a stationary housing;
a rotatable housing mounted within the stationary housing for rotatable about a central axis, the rotatable housing is configured to be selectively engaged and disengaged to the stationary housing;
a hydraulic motor mounted within the rotatable housing, the hydraulic motor including a rotor and a casing;
a first output shaft connected to the rotor of the hydraulic motor for rotation about the central axis, the first output shaft is configured to be selectively engaged and disengaged to the rotatable housing; and
a second output shaft connected to the casing of the hydraulic motor for rotation about the central axis, the second output shaft is configured to be selectively engaged and disengaged to the rotatable housing.

10. The steering apparatus of claim 9 further including a first clutch member associated with the rotatable housing to selectively engage and disengage the first output shaft to the rotatable housing.

11. The steering apparatus of claim 9 further including a second clutch member associated with the rotatable housing to selectively engage and disengage the second output shaft to the rotatable housing.

12. The steering apparatus of claim 9 further including a brake member associated with the stationary housing to selectively engage and disengage the rotatable housing to the stationary housing.

13. The steering apparatus of claim 9 further including,
a first gear assembly driven by the first output shaft, the first gear assembly drives a first drive shaft; and
a second gear assembly driven by the second output shaft, the second gear assembly drives a second drive shaft.

14. The steering apparatus of claim 13, wherein at least one of the first gear assembly and the second gear assembly is a planetary gearing mechanism.

15. The steering apparatus of claim 9, wherein the hydraulic motor is one of an axial piston motor and a radial piston motor.

16. A machine comprising:
a mechanical power source;
a hydraulic power source; and
a steering apparatus, the steering apparatus including:
a stationary housing;
a rotatable housing mounted within the stationary housing for rotatable about a central axis, the rotatable housing is configured to be selectively engaged and disengaged to the stationary housing;
a hydraulic motor mounted within the rotatable housing, the hydraulic motor including a rotor and a casing;
a first output shaft connected to the rotor of the hydraulic motor for rotation about the central axis, the first output shaft is configured to be selectively engaged and disengaged to the rotatable housing; and
a second output shaft connected to the casing of the hydraulic motor for rotation about the central axis, the second output shaft is configured to be selectively engaged and disengaged to the rotatable housing.

17. The machine of claim 16 further including a first clutch member associated with the rotatable housing to selectively engage and disengage the first output shaft to the rotatable housing.

18. The machine of claim 16 further including a second clutch member associated with the rotatable housing to selectively engage and disengage the second output shaft to the rotatable housing.

19. The machine of claim 16 further including a brake member associated with the stationary housing to selectively engage and disengage the rotatable housing to the stationary housing.

20. The machine of claim 16 further including,
a first gear assembly driven by the first output shaft, the first gear assembly drives a first drive shaft; and
a second gear assembly driven by the second output shaft, the second gear assembly drives a second drive shaft.
